(19) United States
(12) Patent Application Publication
(10) Pub. No.: US 2025/0116311 A1
(43) Pub. Date: Apr. 10, 2025

(54) DAMPING ARRANGEMENT

(71) Applicant: Sebert Schwingungstechnik GmbH, Kirchheim/Teck (DE)

(72) Inventor: Karl Sebert, Kirchheim (DE)

(73) Assignee: Sebert Schwingungstechnik GmbH, Kirchheim/Teck (DE)

(21) Appl. No.: 18/832,016

(22) PCT Filed: Jan. 23, 2023
(86) PCT No.: PCT/EP2023/051497

§ 371 Date: Jul. 22, 2024

(30) Foreign Application Priority Data
Jan. 24, 2022 (DE) 102022200733.6

(51) Int. Cl. F16F 7/14; E04B 1/98; F16F 7/08; F16F 15/02

(52) U.S. Cl. CPC F16F 7/14; F16F 7/08; F16F 15/022; E04B 1/98; F16F 2222/04; F16F 2230/0005; F16F 2232/08; F16F 2236/103

(57) ABSTRACT

The invention relates to a damping arrangement comprising a wire or steel cable element (2), passing helically around a longitudinal axis of the damping arrangement (1) in several coils, and a counter-element (3), wherein the counter-element (3) is designed as a bar, wherein a section of the counter-element (3) is arranged non-positively coupled and/or frictionally coupled inside the wire or steel cable element (2) such that the coils of the wire or steel cable element (2) in the section pass around the bar, or wherein the counter-element (3) is designed as a sleeve in which a section of the wire or steel cable element (2) is arranged non-positively coupled and/or frictionally coupled such that the coils of the wire or steel cable element (2) extend inside the section of the sleeve, and wherein the wire or steel cable element (2) and the counter-element (3) are movable relative to one another in the direction of the longitudinal axis (I) such that frictional forces result.

### TECHNICAL FIELD AND PRIOR ART

The invention relates to a damping arrangement. The invention further relates to a damping system and to a device with a damping arrangement or damping system.

Damping arrangements are used for mounting machinery or loads or for earthquake protection.

Vibration isolators comprising a wire or steel cable element, passing helically around a longitudinal axis in several coils and usually subjected to loading transversely to the longitudinal axis during use, are known from the prior art, for example from EP 2 339 202 A1.

The use of vibration elements made of rubber or elastomers which have inherent damping for protection of buildings against earthquakes is known. In addition, the use of hydraulic damping elements, in particular hydraulic cylinders, for that purpose is known, should inherent damping from the rubber vibration elements be insufficient, or if earthquake protection is to be achieved exclusively by hydraulic damping.

### OBJECT AND SOLUTION

One object of the invention is to provide a sturdy and maintenance-free damping arrangement.

In accordance with a first aspect, a damping arrangement is provided, comprising a wire or steel cable element, passing helically around a longitudinal axis of the damping arrangement in several coils, and a counter-element, wherein said counter-element is designed as a bar, wherein a section of the counter-element is arranged non-positively coupled and/or frictionally coupled inside the wire or steel cable element such that the coils of the wire or steel cable element in said section pass around the bar, and wherein the wire or steel cable element and the bar are movable relative to one another in the direction of the longitudinal axis such that frictional forces result.

In accordance with a second aspect, a damping arrangement is provided, comprising a wire or steel cable element, passing helically around a longitudinal axis of the damping arrangement in several coils, and a counter-element, wherein the counter-element is designed as a sleeve inside which a section of the wire or steel cable element is arranged non-positively coupled and/or frictionally coupled such that the coils of the wire or steel cable element extend inside the section of the sleeve, and wherein the wire or steel cable element and the sleeve are movable relative to one another in the direction of the longitudinal axis such that frictional forces result.

In connection with the application, the terms “a” or “an” are generally used as the indefinite article “a/an”, and not as “one” in the numerical sense. In particular, the damping arrangement may have more than one wire or steel cable element and/or more than one counter-element.

The counter-element is, in embodiments of the damping arrangement, made of metal, in particular of special steel, in order to provide a damping arrangement which comprises exclusively metal elements and thus has a very high resistance to wear and does not require high maintenance. The embodiment has in particular the advantage that rubber or elastomer elements which may harden over time, and hydraulic elements which require maintenance, can be dispensed with.

When in use, the damping arrangement is arrangeable such that a movement to be damped is imparted in the direction of the longitudinal axis. When a movement is imparted in the direction of the longitudinal axis, the wire or steel cable element and the counter-element are moved relative to one another, wherein the resultant frictional forces have a damping effect on the relative movement. The damping arrangement permits here absorption of compressive forces and tensile forces in the direction of the longitudinal axis while generating frictional forces.

The frictional forces act here between the wire or steel cable element and the counter-element. The frictional forces arising between the wire or steel cable element and the counter-element, also referred to as external frictional forces, are independent of a relative speed of the elements.

Also, internal damping forces act inside in the wire or steel cable element which depend partly on stranding of the wire or steel cable element.

In one embodiment, it is provided that the wire or steel cable element is, when subjected to loading transversely to the direction of the longitudinal axis, elastically deformable for mounting of the counter-element. The deformation of the wire or steel cable element transversely to the longitudinal axis permits a short-term enlargement of a clear width of a space enclosed by the wire or steel cable element, such that a bar is insertable into said space. When loading transversely to the longitudinal axis ends, the wire or steel cable element is in contact with the bar, wherein a normal force acts between the wire or steel cable element and the bar due to internal resetting forces of the wire or steel cable element. If short-term and abrupt imparting of a movement in the direction of the longitudinal axis occurs, the wire or steel cable element and the counter-element are moved relative to one another, wherein frictional forces, which have a damping effect, arise between the wire or steel cable element and the counter-element.

In one embodiment, a strip extending in the direction of the longitudinal axis is provided, inside which the wire or steel cable element is held, wherein a fastening device is provided in particular at a distal end of the strip. In one embodiment, two strips are provided, which have on sides facing away from one another grooves extending transversely to the direction of the longitudinal axis, wherein the wire or steel cable element passes alternatingly through a groove of the one strip and then through a groove of the other strip. In one embodiment, the strips are in two parts for fixing, wherein the wire or steel cable element is clamped between two strip pieces. In other embodiments, the wire or steel cable element is fixed in the grooves by deformed or crimped grooved-side areas.

In advantageous embodiments, the strips are arranged at a distance from the counter-element, such that a frictional contact exists exclusively between the counter-element and the wire or steel cable element.

In one embodiment, it is provided that the counter-element is designed as a bar, wherein the bar has different extents in the two transverse directions of the damping arrangement, and wherein the bar has in particular a rectangular or an oval, in particular a stadium-shaped, cross-section. The bar is here inserted into the wire or steel cable element such that the strips are opposite the long sides of the bar.

Stadium-shaped in connection with the application refers to an oval shape which is composed of a rectangle and of two circle segments arranged at the narrow sides of the rectangle, in particular two semi-circles. The stadium-shaped cross-section thus has two long sides and two sides with a circular-arc curvature. A bar with a stadium-shaped cross-section permits a large-area frictional contact of the bar with the wire or steel cable element, while preventing any contact between the bar and the strips.

In one embodiment, it is provided that the bar has a longitudinal groove on one long side or on both long sides. The longitudinal groove allows a width of the bar to be enlarged between the long sides, wherein the strips project into the longitudinal grooves and thus contact between the strips and the bar is prevented.

In one embodiment, it is provided that the bar widens in a wedge shape in the direction of its distal end, wherein in particular an extent of a long side of the bar increases, and/or a coil diameter of the wire or steel cable element increases in the direction of the distal end of the bar. Due to the wedge-shaped or funnel-shaped expansion and/or the increase in the coil diameter, an insertion aid is provided, wherein frictional forces between the bar and the wire or steel cable element increase with an insertion depth of the bar into the wire or steel cable element.

In one embodiment, it is provided that the wire or steel cable element has two sections arranged inclined to one another in the direction of the longitudinal axis. An inclination is achievable for example by means of an opposing coil system. This prevents the wire or steel cable element being biased in one direction.

In one embodiment, two counter-elements are provided opposite one another, wherein the counter-elements are movable relative to one another in the direction of the longitudinal axis and relative to the wire or steel cable element while generating frictional forces. The two counter-elements are for example two bars, which are inserted from opposite ends into the space enclosed by the wire or steel cable element.

In accordance with a further aspect, a damping system comprising a damping arrangement and an elastically deformable resetting arrangement is provided, wherein a resetting force is applicable by means of the resetting arrangement. In other words, the resetting arrangement effects a resetting movement of the damping arrangement into an initial position after cessation of an imparted movement, for example after cessation of a momentum acting on it.

In accordance with a further aspect, a device is provided for vibration-isolated mounting of objects, in particular buildings, comprising a damping arrangement as described above and/or a damping system with a damping arrangement as described above.

In one embodiment, the device is used for protection against earthquakes, wherein non-metal components and/or hydraulic elements can be dispensed with and thus a maintenance-free device provided.

### BRIEF DESCRIPTION OF THE DRAWINGS

Further advantages and aspects of the invention can be found in the claims and in the description of examples of the invention that are explained in the following on the basis of the schematic figures. Uniform reference numerals are used here for identical or similar components. The drawing shows in:

FIG. 1: a first example of a damping arrangement in a perspective illustration;

FIG. 2: the damping arrangement according to FIG. 1 in a side view;

FIG. 3: the damping arrangement according to FIG. 1 in a section III-III according to FIG. 2;

FIG. 4: the damping arrangement according to FIG. 1 in a plan view;

FIG. 5: a second example of a damping arrangement in a perspective illustration;

FIG. 6: the damping arrangement according to FIG. 5 in a plan view;

FIG. 7: a third example of a damping arrangement in a perspective illustration;

FIG. 8: the damping arrangement according to FIG. 5 in a plan view;

FIG. 9: a fourth example of a damping arrangement in a perspective illustration;

FIG. 10: the damping arrangement according to FIG. 9 in a side view;

FIG. 11: a fifth example of a damping arrangement in a perspective illustration; and

FIG. 12: the damping arrangement according to FIG. 11 in a side view;

FIG. 13: a building with a first example of a device comprising a damping system for earthquake protection; and

FIG. 14: a building with a second example of a device comprising a damping system for earthquake protection.

### DETAILED DESCRIPTION OF THE EXAMPLES

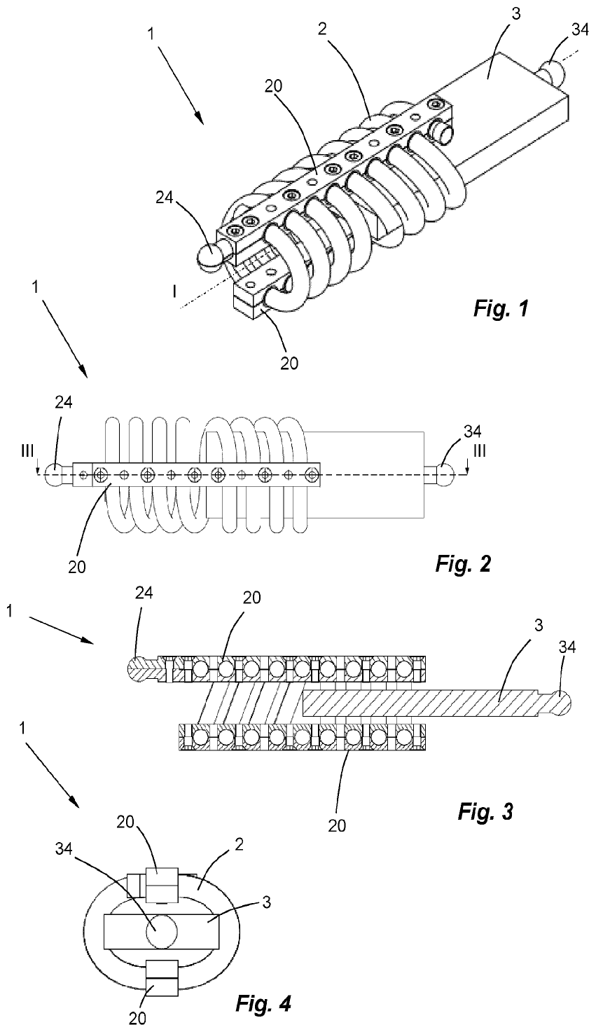

FIGS. 1 to 4 show schematically a damping arrangement 1 in a perspective illustration, side view, sectional view and plan view respectively.

The damping arrangement 1 comprises a wire or steel cable element 2 and a counter-element 3 made of metal. The wire or steel cable element 2 passes in several coils helically around a longitudinal axis I of the damping arrangement 1, such that an interior space enclosed by the coils is created. In the example shown in FIG. 1, the wire or steel cable element 2 has two sections each with four coils, wherein the coils of the two sections have a different winding direction and are therefore inclined relative to one another in the direction of the longitudinal axis I. Closure caps are provided at free ends of the wire or steel cable element 2 to prevent twisting of the wire or steel cable element 2.

The wire or steel cable element 2 extends between two strips 20 arranged at a distance to one another. In the example shown, each strip 20 comprises two strip pieces between which the coils of the wire or steel cable element 2 are clamped.

The strip pieces are riveted to one another in the example shown. In other embodiments, the strip pieces are glued, bolted or otherwise detachably or undetachably connected to one another. In the example shown, through-holes are provided in the strip piece between the rivets and are used to hold the strip 20 during mounting of the wire or steel cable element 2. In other embodiments, through-holes of this type are not provided.

The counter-element 3 shown is designed as a bar, wherein a section of the counter-element 3 is arranged in an interior space of the wire or steel cable element 2 created by the coils, such that the coils pass around the counter-element 3 in this section.

As is best seen in FIG. 4, the counter-element 3 shown has a rectangular cross-section with two long sides and two narrow sides. The counter-element 3 is inserted into the wire or steel cable element 2 such that the long sides are arranged opposite the strips 20, wherein the long sides are at a distance to the strips 20 and the narrow sides are contacting the wire or steel cable element 2.

Fastening elements 24, 34 are provided on one of the two strips 20 and on the counter-element 3 at opposite ends of the damping arrangement 1. In the example shown, spherical fastening elements 24, 34 are provided. In the example shown, a fastening element 24 is provided on only one of the two strips 20. In other embodiments, a fastening element 24 is provided on both strips 20, or a fastening element 24 is provided which acts on both strips 20.

For insertion of the counter-element 3, the wire or steel cable element 2 is subjected to loading in a direction transversely to the longitudinal axis I by means of a mounting force such that the strips 20 are moved towards one another. As a result, the wire or steel cable element 2 is elastically deformed such that a clear width transversely to the effective direction of the mounting force and transversely to the longitudinal axis I increases. This allows the counter-element 3 to be inserted into the coils of the wire or steel cable element 2. When the mounting force ends, the counter-element 3 is held non-positively inside the wire or steel cable element 2 due to the elastic resetting forces of said wire or steel cable element 2.

When in use, the damping arrangement 1 is arranged such that a movement imparted from the outside effects a relative movement in the direction of the longitudinal axis I. When a movement is imparted, the wire or steel cable element 2 and the counter-element 3 are moved relative to one another in the direction of the longitudinal axis I, wherein frictional forces arise which have a damping effect on the movement.

As already mentioned, in the example shown spherical fastening elements 24, 34 are provided such that the damping arrangement 1 is receivable at both ends by swiveling it into a suitable mounting unit. This permits an easy attachment of the damping arrangement 2 between two elements (not shown) at a distance apart in the direction of the longitudinal axis I and movable within a tolerance range in a plane vertical to the longitudinal axis I.

The damping arrangement 1 is in particular arrangeable such that the longitudinal axis I extends in the vertical direction. Depending on the particular use, the counter-element 3 may be arranged here at a lower end or at an upper end of the damping arrangement 1.

In one embodiment, the damping arrangement 1 is used in combination with an elastically deformable resetting arrangement (not shown), wherein a resetting force is applicable by means of the resetting arrangement such that when the load causing the relative movement ends, the damping arrangement 1 is returnable into an initial position.

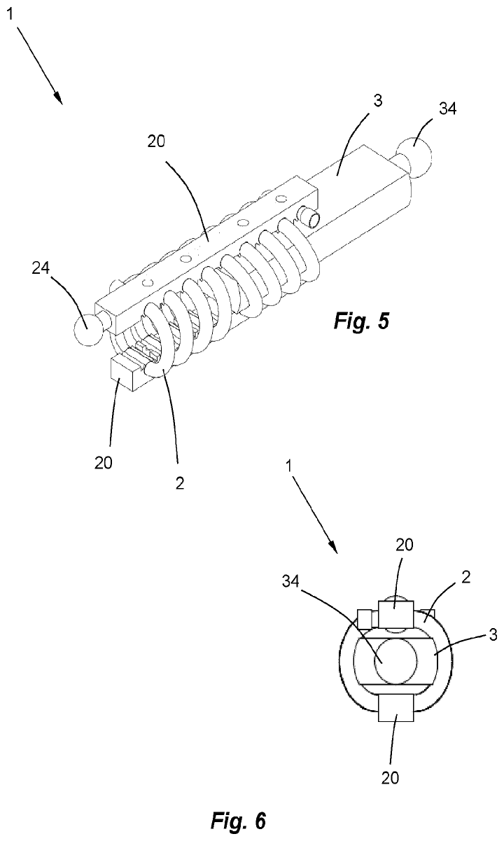

FIGS. 5 to 12 show schematically further examples of damping arrangements 1 similar to the damping arrangement 1 according to FIG. 1. Uniform reference numerals are used in the figures for identical or similar components. As may be discerned by the person skilled in the art, the examples shown are only by way of example. In particular, it is possible for the person skilled in the art to combine elements shown as parts of one example with elements shown as parts of another example, in order to arrive in this way at further embodiments.

FIGS. 5 and 6 show schematically a second example of a damping arrangement 1 with a wire or steel cable element 2 and with a counter-element 3 designed as a bar, in a perspective illustration and in a plan view respectively.

Unlike in the damping arrangement 1 according to FIG. 1, a counter-element 3 with an oval, in particular a stadium-shaped, cross-section is provided in the example according to FIGS. 5 and 6. The cross-sectional shape makes it possible to enlarge a contact area between the wire or steel cable element 2 and the counter-element 3 with the same size of the wire or steel cable element 2 when compared to the design according to FIG. 1, since on the one hand contact is possible in the circumferential direction and on the other hand a wider design of the counter-element 3 is possible between the two strips 20 with the same clear width during mounting.

The example shown in FIGS. 5 and 6 also differs from that shown in FIG. 1 in the design of the strips 2. The strips 2 according to FIGS. 5 and 6 are each one-piece and have grooves with plastically deformable webs, wherein coils of the wire or steel cable element 2 are insertable into the grooves and are fastenable in said grooves with plastic deformation of the webs.

It may be discerned by the person skilled in the art that the design of the strips 2 is here independent of the design of the counter-element 3. The combination is however advantageous, since the strips 2 according to FIGS. 5 and 6 are of small size and hence project to a lesser extent into an interior space created by the coils. This also permits a wider design of the counter-element 3 between the two strips 20.

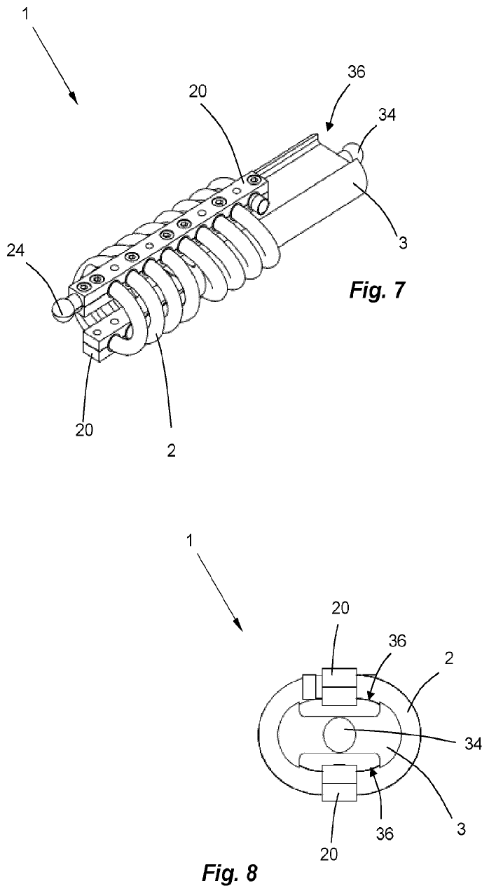

FIGS. 7 and 8 show schematically a third example of a damping arrangement 1 with a wire or steel cable element 2 and with a counter-element 3 designed as a bar, in a perspective illustration and in a plan view respectively.

Unlike in the damping arrangement 1 according to FIG. 1, a counter-element 3 with an oval, in particular stadium-shaped, cross-section is provided in the example according to FIGS. 7 and 8. The counter-element 3 also has longitudinal grooves 36 on its long sides facing the strips 2. The cross-sectional shape and the longitudinal grooves make it possible to enlarge a contact area between the wire or steel cable element 2 and the counter-element 3, with the same size of the wire or steel cable element 2, when compared to the design according to FIG. 1, since—as seen in the example according to FIGS. 5 and 6—contact in the circumferential direction is possible, and also a wider design of the counter-element 3 is possible between the two strips 20 with the same clear width during mounting. A collision of the counter-element 3 with the strips 2 is also prevented by the longitudinal grooves 36, such that the counter-element 3 only touches the wire or steel cable element 2, but not the strips 2.

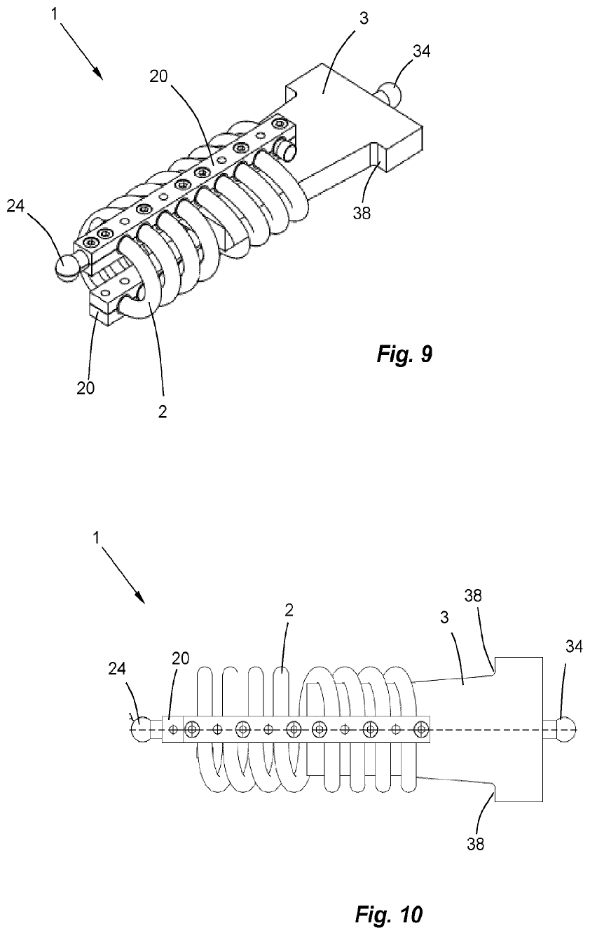

FIGS. 9 and 10 show schematically a fourth example of a damping arrangement 1 with a wire or steel cable element 2 and with a counter-element 3 designed as a bar, in a perspective illustration and in a plan view respectively.

Unlike in the damping arrangement 1 according to FIG. 1, a counter-element 3 widening in a wedge shape is provided in the example according to FIGS. 9 and 10. In the example shown, the counter-element 3 has a rectangular cross-section with two long sides and two narrow sides, wherein an extent of the long side of the counter-element 3 increases in the direction of a distal end of the counter-element 3. The wedge-shaped design of the counter-element 3 serves here as an insertion aid during mounting and in use, wherein frictional forces between the wire or steel cable element 2 and the counter-element 3 increase with an insertion depth of the counter-element 3.

In the example shown, a stop 38 is also provided, by means of which a maximum insertion depth is limited. A stop of this type may also be provided in other designs of the counter-element 3.

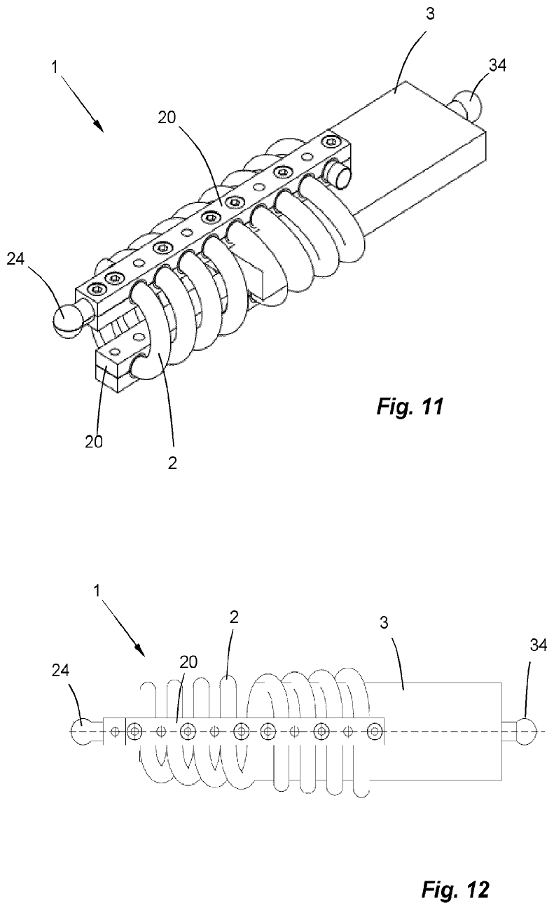

FIGS. 11 and 12 show schematically a fifth example of a damping arrangement 1 with a wire or steel cable element 2 and with a counter-element 3 designed as a bar, in a perspective illustration and in a plan view respectively.

Unlike in the damping arrangement 1 according to FIG. 1, a wire or steel cable element 2 with several coils is provided in the example according to FIGS. 11 and 12, wherein a coil diameter of the wire or steel cable element increases in the direction of the distal end of the counter-element 3. The increasing coil diameter acts here as an insertion aid during mounting and in use, wherein frictional forces between the wire or steel cable element 2 and the counter-element 3 increase with an insertion depth of the counter-element 3.

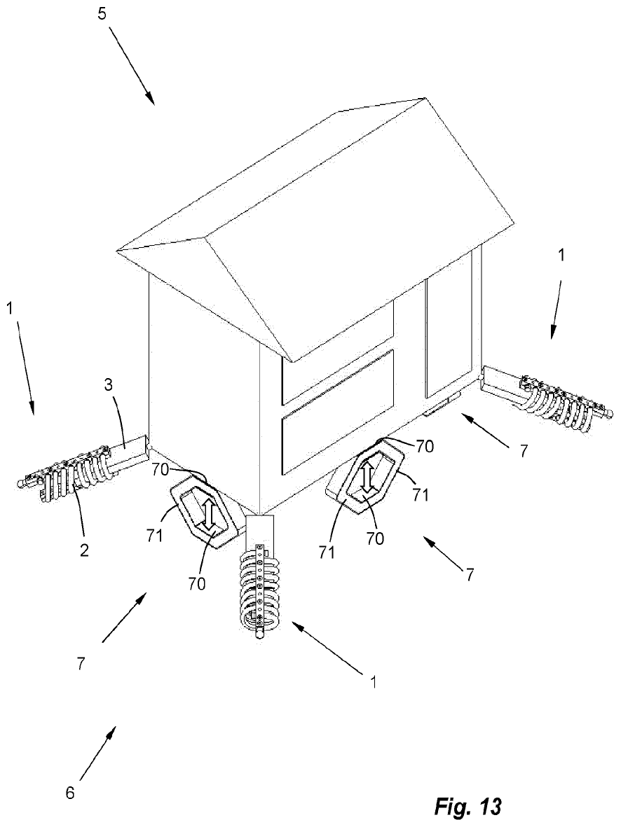

FIG. 13 shows schematically a building 5 and a device 6 comprising a damping system with several damping arrangements 1, four in the example shown, for earthquake protection. In the example shown in FIG. 13, the building 5 has a rectangular foundation. The damping arrangements 1 are arranged at the four corners of the foundation, with only three damping arrangements 1 being shown in FIG. 13. The damping arrangements 1 are each arranged obliquely. A connection of the damping arrangements 1 to the building 5 and to a subsurface is made preferably using cardanic mounts (not shown), such that in the event of an earthquake movement of the building 5 relative to the subsurface is possible with all six degrees of freedom. Frictional forces between the wire or steel cable elements 2 and the counter-elements 3 of the damping arrangements 1 have a damping effect here.

The device shown in FIG. 13 comprises in addition to the damping arrangements 1 several resetting arrangements 7, four in the example shown, wherein only three resetting arrangements 7 are visible in FIG. 13. The resetting arrangements 7 are arranged at the sides of the foundation in the example shown in FIG. 13. The resetting arrangements shown are diamond-shaped with two flat connection areas 70 opposite one another, which—as indicated schematically by arrows—are moved closer to one another by the deformation of two V-shaped side members 71. The resetting arrangements 7 are, in the example according to FIG. 13, arranged such that tips of the side members 71 are moved in a direction parallel to sides of the foundation of the building. The resetting arrangements 7 are elastically deformed and apply resetting forces.

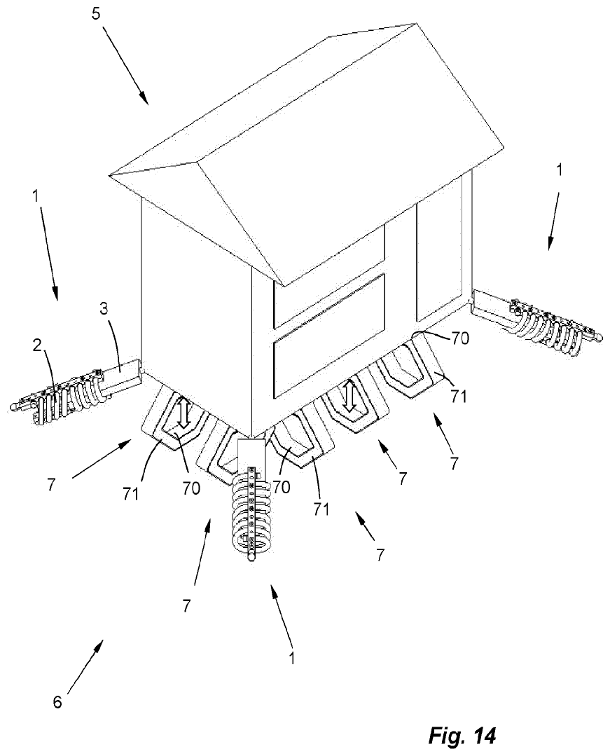

FIG. 14 shows schematically a building 5 and a second example of a device 6 comprising a damping system with several damping arrangements 1, four in the example shown, and several resetting arrangements 7.

The resetting arrangements 7 shown in FIG. 14 are identical to the resetting arrangements 7 according to FIG. 13 and have two flat connection areas 70 opposite one another and two V-shaped side members 71. Unlike in the design according to FIG. 13, the resetting arrangements 7 are arranged in the example according to FIG. 14 such that tips of the side members 71 are moved during deformation in a direction vertical to sides of the foundation of the building 5. Several resetting arrangements 7 are arranged on each side in this case.

The size ratios shown for the building 5, the damping arrangements 1 and the resetting arrangements 7, and the number and the placing of the damping arrangements 1 and of the resetting arrangements 7 in FIGS. 13 and 14, are only by way of example. Layout is performed, depending on the application, in a suitable manner by the person skilled in the art to obtain reliable earthquake protection against differing earthquake tremors.

Instead of or additionally to the diamond-shaped resetting arrangements 7 as shown, other resetting arrangements 7 are provided in other examples, for example helical spring elements.

Use of the damping systems 6 shown is not restricted to earthquake protection. The damping systems 6 are used for example in alternative embodiments for mounting objects on a ship.

1. A damping arrangement comprising a wire or steel cable element, passing helically around a longitudinal axis of the damping arrangement in several coils, and a counter-element, wherein the counter-element is designed as a bar, wherein a section of the counter-element is arranged non-positively and/or frictionally coupled inside the wire or steel cable element such that the coils of the wire or steel cable element in said section pass around the bar, or wherein the counter-element is designed as a sleeve in which a section of the wire or steel cable element is arranged non-positively coupled and/or frictionally coupled such that the coils of the wire or steel cable element extend inside the section of the sleeve, and wherein the wire or steel cable element and the counter-element are movable relative to one another in the direction of the longitudinal axis such that frictional forces result.

2. The damping arrangement according to claim 1, wherein the wire or steel cable element is, when subjected to loading transversely to the direction of the longitudinal axis, elastically deformable for mounting of the counter-element.

3. The damping arrangement according to claim 1, wherein a strip extending in the direction of the longitudinal axis is provided, inside which the wire or steel cable element is held, wherein a fastening device is provided in particular at a distal end of the strip.

4. The damping arrangement according to claim 1, wherein the counter-element is designed as a bar, wherein the bar has different extents in the two transverse directions of the damping arrangement, wherein the bar has in particular a rectangular or an oval, in particular a stadium-shaped, cross-section.

5. The damping arrangement according to claim 4, wherein the bar has a longitudinal groove on one long side.

6. The damping arrangement according to claim 4, wherein the bar widens in a wedge shape in the direction of its distal end, wherein in particular an extent of a long side of the bar increases, and/or a coil diameter of the wire or steel cable element increases in the direction of the distal end of the bar.

7. The damping arrangement according to claim 1, wherein the wire or steel cable element has two sections arranged inclined to one another in the direction of the longitudinal axis.

8. The damping arrangement according to claim 1, wherein two counter-elements are provided opposite one another, wherein the counter-elements are movable relative to one another in the direction of the longitudinal axis and relative to the wire or steel cable element while generating frictional forces.

9. A damping system comprising a damping arrangement according to claim 1, and an elastically deformable resetting arrangement is provided, wherein a resetting force is applicable by means of the resetting arrangement.

10. A device for vibration-isolated mounting of objects, in particular buildings, comprising a damping arrangement according to claim 1.

11. The device according to claim 10, further comprising a dampening system that comprises an elastically deformable resetting arrangement, wherein a resetting force is applicable by means of the resetting arrangement.
